(19) United States
(12) Patent Application Publication
(10) Pub. No.: US 2017/0063138 A1
(43) Pub. Date: Mar. 2, 2017

(54) WIRELESS CHARGING DEVICE

(71) Applicants: CHIH CHUNG CHEN, Hsin Chuang (TW); SHU-MU CHEN, Hsin Chuang (TW)

(72) Inventors: CHIH CHUNG CHEN, Hsin Chuang (TW); SHU-MU CHEN, Hsin Chuang (TW)

(21) Appl. No.: 15/008,501

(22) Filed: Jan. 28, 2016

(30) Foreign Application Priority Data
Aug. 26, 2015 (CN) 201520650604.0

(51) Int. Cl. H02J 7/02; H02J 7/00

(52) U.S. Cl. CPC H02J 7/025; H02J 7/0042

(57) ABSTRACT

A wireless charging device mounting on a mounting hole of furniture, comprises a protection box receiving a wireless charging module, a bolt circle located on the protection box, a fixing plate, an electrical wire. A protruded surface protrudes from a periphery of the protection box, the protruded surface of the protection box is attached with a top surface of the furniture, the fixing plate is connected with the coil bolt through threads. When the wireless charging device is mounted on the furniture, the protection box is mounted in the mounting hole, a dimension of the mounting hole is slightly less than a dimension of the protruded surface, then the fixing plate is rotated to adjust a height of the fixing plate, such that the top surface of the furniture is located between the fixing plate and the protruded surface.

### BACKGROUND

1. Technical Field

The present disclosure generally relates to a wireless charging device, and especially relates to a wireless charging device mounted on furniture.

2. Description of Related Art

With the progress of society and the development of technology, mobile devices have a great variety. However, power consumption of the mobile devices are large, such that how to charging the mobile devices in time is a big problem.

In market, the wireless charging devices emerge as the times require and develop prosperously. However, a mounting process of mounting the wireless charging device to the furniture is very troubling and ugly. And the traditional wireless charging device are inconvenience.

Therefore, a need exists in the industry to overcome the described problems.

### SUMMARY

The disclosure is to offer a system and method of wireless charging devices.

A wireless charging device comprises a protection box located in a mounting hole of a furniture, a bolt circle, a fixing plate, an electrical wire, a protruded surface protruding from a periphery of the protection box, the protruded surface of the protection box is attached with a top surface of the furniture, a wireless transmitting module is located inside the protection box, the protection box also has an inner cavity; the bolt circle is located on a bottom of the protection box, the bolt circle has an inner hole, the inner hole is connected with the inner cavity of the protection box; the fixing plate is fixed on the bolt circle through threads, the fixing plate is located on a bottom surface of the furniture; the electrical wire passes through the inner hole to be electrically connected with the wireless transmitting module, the wireless charging device is located on the furniture having different thickness to charge devices.

Preferably, the protection box includes a top cover and a bottom cover, the top cover is connected with the bottom cover through screws or snaps, the top cover and the bottom cover cooperatively form the inner cavity, the wireless transmitting module is located inside the inner cavity.

Preferably, when the protection box is mounted in the furniture, a gasket is located between the protruded surface and a top surface of the furniture, the gasket keeps out water and dust.

Preferably, wherein the wireless transmitting module includes a printed circuit board electrically connected with the electrical wire, a disk located on the printed circuit board, a coil located on the disk.

Preferably, a shape of the fixing plate is strip-shaped, two supporters are formed on two opposite ends of the fixing plate, the supporters are contacted with the bottom surface of the furniture.

Compared to the traditional wireless charging device, the protection box of the present invention is located in the mounting hole of the furniture, and the fixing plate is located at the bottom surface of the furniture, the distance between the fixing plate and the protection box is adjusted by rotating the fixing plate around the bolt circle, such that the protection box is fixed tightly in the furniture, and the fixing process is easy. Structure of the wireless charging device is simple.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled view of a wireless charging device mounted on a furniture according to an exemplary embodiment.

FIG. 2 is an isometric view of the wireless charging device.

FIG. 3 is an exploded view of the wireless charging device.

FIG. 4 is another exploded view of the wireless charging device.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

The present invention provides a wireless charging device which can be mounted in a mounting hole 101 of a furniture 10, then a fixing plate 40 can be rotated to fix the wireless charging device into the furniture 10, during the fixing process, the fixing plate 40 moves gradually towards the mounting hole 101, a distance between the fixing plate 40 and the mounting hole 101 is gradually decreased. That is, a height of the fixing plate 40 is adjusted to fix the fixing plate 40 on the furniture 10. Thicknesses of the mounting holes 101 of different furniture 10 are different, the wireless charging device can be mounted into different furniture by adjusting the height of the fixing plate 40, and the top surface of the furniture 10 is located between the fixing plate 40 and the protruded surface.

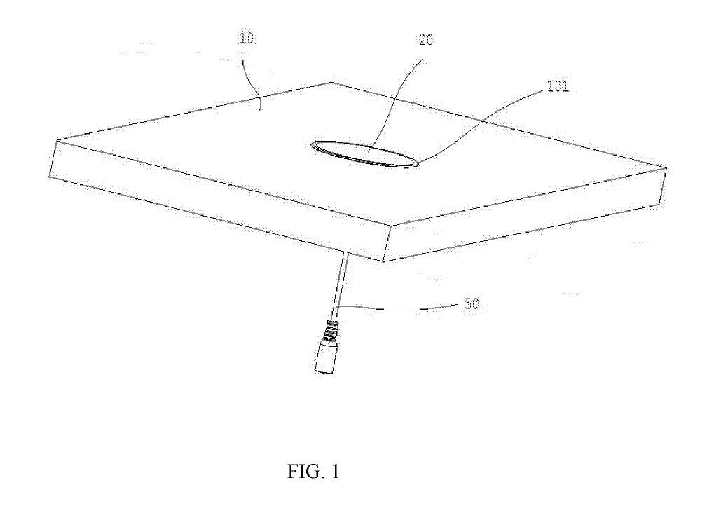

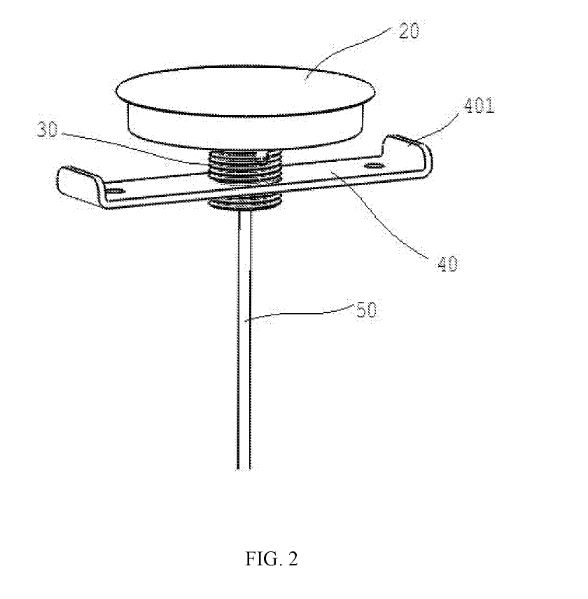

Referring to FIGS. 1-2, the wireless charging device includes a protection box 20, a wireless transmitting module 60, a bolt circle 30, the fixing plate 40 and an electrical wire 50.

The protection box 20 can be mounted in the preset mounting hole 101 of the furniture 10. A protruded surface is protruded from a periphery of the protection box 20, the protruded surface of the protection box 20 is attached tightly with a top surface of the furniture 10.

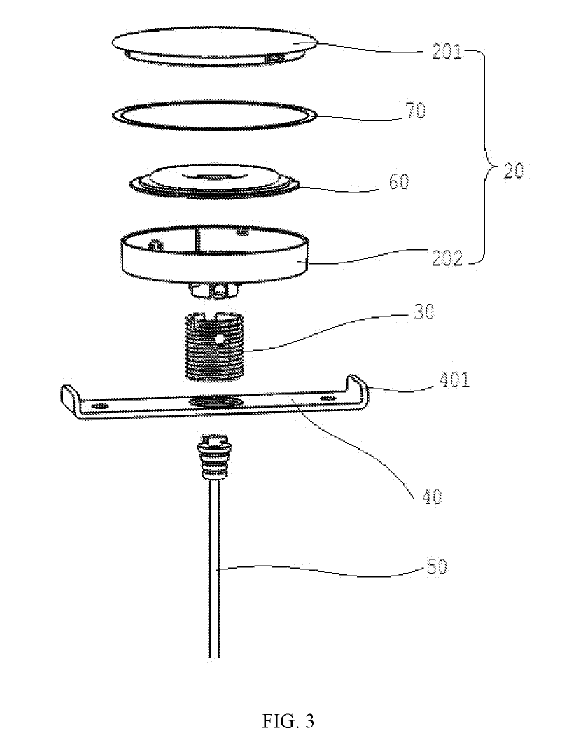

Referring to FIG. 3, the wireless transmitting module 60 is located inside the protection box 20, and can transfer an electrical signal to a magnetic field, such that devices (not shown) located in the magnetic field can be charged.

The bolt circle 30 is fixed on a bottom surface of the protection box 20. The bolt circle 30 has external threads and an inner hole, the inner hole passes through the bolt circle 30. The inner hole is connected with an inner cavity of the protection box 20.

The fixing plate 40 has a threaded hole which has internal threads, the internal threads of the threaded hole are corresponding to the external threads of the bolt circle 30. The fixing plate 40 is fixed with the bolt circle 30 through the internal threads. Shape of the fixing plate 40 can be strip-shaped, two supporters 401 are formed on two opposite ends of the fixing plate 40. When the wireless charging device is mounted on the furniture 10, the supporters 401 are contacted with a bottom surface of the furniture 10.

The electrical wire 50 passes through the bolt circle 30 to electrically connect with the wireless transmitting module 60, which is located inside the inner cavity of the protection box 20.

In at least one exemplary embodiment, when the wireless charging device is mounted on the furniture 10, the protection box 20 is mounted inside the mounting hole 101 of the furniture 10 first; then the fixing plate 40 is mounted on the protection box 20 from the bottom of the protection box 20, the fixing plate 40 is rotated until the supporters 401 resist on the bottom surface of the protection box 20, such that the wireless charging device can be mounted on the furniture 10.

As the height of the fixing plate 40 can be adjusted by rotating the fixing plate 40, and a rotating number of the fixing plate 40 corresponds to the height of the fixing plate 40, such that the wireless charging device can be mounted on different furniture 10 having different thicknesses.

Furthermore, the protection box 20 includes a top cover 201 and a bottom cover 202, the top cover 201 can be detachably connected with the bottom cover 202 through screws or snaps, and the top cover 201 and the bottom cover 202 cooperatively form the inner cavity, the wireless transmitting module 60 is located inside the inner cavity.

The transmitting module 60 is located inside the top cover 201 and the bottom cover 202, the top cover 201 can be easily separated from the bottom cover 202, such that the wireless transmitting module 60 can be are repaired easily.

In at least one exemplary embodiment, a dimension of the protruded surface of the top cover 201 is slightly larger than a dimension of the mounting hole 101 of the furniture 10.

Furthermore, when the protection box 20 is mounted on the furniture 10, a gasket 70 can be located on the top cover 201 top surface of the furniture 10, the gasket 70 is directly contacted with the protruded surface of the top cover 201 and the top surface of the furniture 10. The gasket 70 keeps out dust and water. Furthermore, the gasket 70 is located between the protruded surface and the top surface of the furniture.

The gasket 70 can be made of a resin. The gasket 70 is soft.

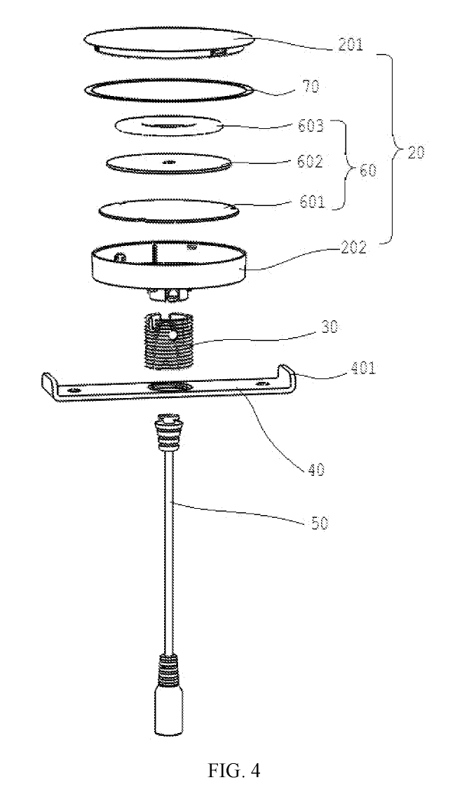

Referring to FIG. 4, furthermore, the wireless transmitting module 60 includes a printed circuit board 601 electrically connected with the electrical wire 50, a disk 602 located on the printed circuit board 601, a coil 603 located on the disk 602. In at least one exemplary embodiment, the printed circuit board 601 can transfer an electric energy transmitted from the printed circuit board 601 into magnetic field energy.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A wireless charging device, comprising,
a protection box located in a mounting hole of a furniture, a protruded surface protruding from a periphery of the protection box, the protruded surface of the protection box attached to a top surface of the furniture, a wireless transmitting module located inside the protection box, the protection box having an inner cavity;
a bolt circle located on a bottom of the protection box, the bolt circle having an inner hole, the inner hole being connected with the inner cavity of the protection box;
a fixing plate fixed on the bolt circle through threads, the fixing plate being located on a bottom surface of the furniture;
an electrical wire passing through the inner hole to be electrically connected with the wireless transmitting module, the wireless charging device being located on the furniture having different thickness to charge devices.

2. The wireless charging device of claim 1, wherein the protection box includes a top cover and a bottom cover, the top cover is connected with the bottom cover through screws or snaps, the top cover and the bottom cover cooperatively form the inner cavity, the wireless transmitting module is located inside the inner cavity.

3. The wireless charging device of claim 2, wherein when the protection box is mounted in the furniture, a gasket is located between the protruded surface and a top surface of the furniture, the gasket keeps out water and dust.

4. The wireless charging device of claim 1, wherein the wireless transmitting module includes a printed circuit board electrically connected with the electrical wire, a disk located on the printed circuit board, a coil located on the disk.

5. The wireless charging device of claim 2, wherein the wireless transmitting module includes a printed circuit board electrically connected with the electrical wire, a disk located on the printed circuit board, a coil located on the disk.

6. The wireless charging device of claim 1, wherein a ship of the fixing plate is strip, two supporters are formed on two opposite ends of the fixing plate, the supporters are contacted with the bottom surface of the furniture.
